(19) United States
(12) Patent Application Publication
(10) Pub. No.: US 2023/0341177 A1
(43) Pub. Date: Oct. 26, 2023

(54) METHOD AND DEVICE FOR OPERATING A CRYOGENIC TUNNEL

(71) Applicant: L'Air Liquide, Societe Anonyme pour l'Etude et l’Exploitation des Procedes Georges Claude, Paris (FR)

(72) Inventors: Didier PATHIER, Shanghai (CN); Christian REYMOND, Jouy-en-Josas (FR); Olivier POUCHAIN, Carquefou (FR); Gilles GAUBERT, Paris (FR)

(73) Assignee: L'Air Liquide, Societe Anonyme pour l'Etude et l’Exploitation des Procedes Georges Claude, Paris (FR)

(21) Appl. No.: 18/138,706

(22) Filed: Apr. 24, 2023

(30) Foreign Application Priority Data
Apr. 25, 2022 (FR) FR 2203801

(51) Int. Cl. G05B 19/4155; F25D 29/00

(52) U.S. Cl. CPC F25D 29/001; G05B 19/4155; F25D 13/06

(57) ABSTRACT

A method and device for operating a cryogenic tunnel involving the implementation of the following provisions:
the measurement of a plurality of key parameters of the method,
the division of these parameters into two groups of different parameters,
the implementation of one or both of the two following actions on these key parameters:
   Anticipation actions on the parameters of the 1^{st} group (in order to act in advance on an anticipated/expected deviation in the deep-freezing quality; and
   Retroactive actions (countermeasures) on the parameters of the second group, in order to rebalance a measured, effective drift in the quality of the exiting products.

### CROSS-REFERENCE TO RELATED APPLICATIONS

This application claims the benefit of priority under 35 U.S.C. § 119 (a) and (b) to FR patent application No. FR 2203801, filed Apr. 25, 2022, the entire contents of which are incorporated herein by reference.

### FIELD OF THE INVENTION

The present invention relates to a method and a device for operating a cryogenic tunnel, the tunnel being of the type in which products to be cooled or deep-frozen circulate, which is equipped with means for injecting a cryogenic fluid and with means for extracting cold gases resulting from the vaporization of the fluid in the tunnel.

### BACKGROUND

The document US 5 606 861 illustrates the state of this technical field in the case of so-called “IQF” products (individual deep-freezing of products such as fruits, vegetables, patties, etc.).

In this industry, users adjust the key operating parameters of the tunnel in order to maintain optimized production.

Among these parameters there are the temperature setpoint prevailing inside the tunnel, the speed of the conveyor and the speed of the blowers.

As is known, these parameters greatly influence the quality of the products obtained and the cost of the method through the consumption of cryogen, hence the importance of it being possible to optimize these parameters.

However, it is well known that the operating conditions of such tunnels are not stable, they vary depending on the batches of products treated: in certain cases the temperature of the entering products varies, in other cases the thickness of the products varies from one batch to another, while in other cases the flow rate of products to be treated or the composition of the products changes in the course of the day.

In this context, the optimization of the production parameters is a very complex objective, and in practice, the users of such tunnels do not adjust the parameters of the tunnel continuously during production processes, in fact they choose to adopt a “mean” setting which is intended to cover most of their production processes as correctly as possible.

Thus, for example, it has been observed that during a given production process the cooling power is too high, and so the temperature of the products exiting the tunnel is too low, this not necessarily causing a drop in quality depending on the products in question.

In other cases, the cooling power is too low, and so the temperature of the products exiting the tunnel is too high; this time, this causes a serious problem of quality and acceptability of the products obtained, and may result in the rejection of the products in question and the need to restart a production process.

This is one of the reasons for which producers prefer, for safety reasons, to adjust their setpoint temperature slightly too low, although this does of course represent a significant cost.

### SUMMARY

One solution to this problem would be to continuously adjust the operating conditions of the tunnel so that the product is cooled or deep-frozen just to the desired level, for example on the basis of a temperature measurement carried out on the products exiting the tunnel and a retroactive action on the cryogen supply conditions: if the temperature of the products at the outlet is lower than the target, the temperature of the tunnel will be increased, whereas if the temperature of the products at the outlet is too high, the temperature of the tunnel will be rapidly lowered.

Another solution could be based on the temperature of the products entering the tunnel: when the products arrive at a temperature higher than intended, the tunnel passes into a mode adopting a lower setpoint, whereas when the products arrive at a temperature lower than intended, the tunnel passes into a mode adopting a higher temperature setpoint, promoting reduced consumption of cryogen.

The literature in this field mentions in particular the following technical solutions:
The Callifreeze® system from the company GEA, in the field of (non-cryogenic) mechanical cooling in which a controller carries out this continuous adjustment of the parameters of the tunnel by continuously monitoring the content of crystallized water in the products, and by accordingly adjusting the residence time of the products in the tunnel, the temperature of the air inside the tunnel, and the speed of the blowers, in order to achieve the desired level of deep-freezing, thereby minimizing the consumption of energy and maintaining an optimum product quality. To this end, a probe is positioned at the tunnel outlet, said probe measuring the “level of deep-freezing” of the products, meaning that when x% of the water in the product is frozen, x% of the product is considered to be deep-frozen. This level is calculated using microwave measurements and with the aid of comparison tables. When the level of deep-freezing is too low, the controller takes retroactive action on the speed of the blowers to increase it, and when this level of deep-freezing is too high, the tunnel is understood to be supplying too much cold energy to the products and is consuming too much energy, the controller than taking retroactive action on the speed of the blowers to decrease it.
The system described in the document WO 2011/136900 A1: this system is based on a measurement of the quantity of products entering the tunnel and on the use of an infrared sensor measuring the temperature of an entering product, or even also of the exiting products, the controller than collecting all of these data to calculate the quantity of cryogen that should be injected into the tunnel to reduce the temperature of the exiting products to a desired level.
The system described in the document EP-3 170 404 B1: this system is based on the employment of a scanning laser, at the inlet of the tunnel, for acquiring a cross-sectional image of an entering product, while an infrared temperature probe is positioned downstream of the laser at the inlet and a second infrared probe is positioned at the outlet of the tunnel.

A controller manages all of these sensors and is able to automatically adjust the thermal transfer to the products by acting on the cryogen feed.

While the solutions listed above undoubtedly provide an improvement to the method and in particular to the quality of the products obtained, the Applicant for its part considers further improvements to be necessary and that these may be obtained according to the invention using the following approach:
By the measurement of a plurality of key parameters of the method.
By the division of these parameters into two groups of different parameters, characterizing the tunnel:
   a first group for parameters which may and will be used to anticipate the future necessary deep-freezing power of the tunnel. This first group comprises for example one or more parameters from the following parameters:
      The temperature of the products entering the tunnel,
      The volumetric flow rate of the entering products,
      The mass flow rate of the products entering the tunnel,
      The colour of the products entering the tunnel,
      The level of coverage of the conveyor belt supplying the tunnel, or
      Parameters characterizing the atmosphere surrounding the tunnel in the room: ambient temperature, ambient humidity and atmospheric pressure.
   It will be understood for example that if the temperature of the products arriving at the inlet of the tunnel increases, the tunnel will need to supply more cold energy. An attempt will thus be made to compensate the energy difference of the products as exactly as possible. By way of illustration, if the products normally have an energy level of 100 kcal/kg and they suddenly arrive in a hotter state with an energy of 122 kcal/kg, an attempt will then be made to compensate for the additional 22 kcal/kg by supplying an additional 22 k of cold energy/kg into the tunnel.
   a second group of parameters which may and will be used to evaluate the final result of the exiting products (including the temperature of the products exiting the tunnel), which parameters will in particular indicate whether the product has been correctly deep frozen. This second group comprises for example one or more parameters from the following parameters:
      The temperature of the (deep-frozen) products exiting the tunnel,
      The flow rate of cryogen let into the tunnel,
      The temperature of the gases extracted from the tunnel, typically at two extraction hoods situated at the tunnel inlet and outlet,
      The temperature prevailing in the room in the vicinity of these two extraction hoods,
      The hardness of the products exiting the tunnel,
      The colour of the products exiting the tunnel,
      The percentage of the deep-frozen products that are of the IQF type (i.e. individual products, of the fruit, vegetable, patty type, etc.). For example, the number of particles of product that are stuck together could be counted and the following calculation carried out: percentage of IQF product = 100 x number of non-stuck particles/total number of particles.
      A particle is understood here to be for example a pea, a bean, a raspberry, a chicken nugget, a rasher of bacon, a piece of fish, etc.
By the implementation of one or both of the two following actions on the basis of the values obtained for these key parameters:
   anticipation actions, calculated on the basis of the values obtained by the parameter or parameters of the 1^{st} group (in order to act in advance on an anticipated/expected deviation in the deep-freezing quality, for example because the temperature of the entering products is too high) of anticipated actions, that is to say actions on the tunnel even before the product exits in too hot or too cold a state, in other words, there is no need for example to wait to measure temperatures of exiting deep-frozen products that are too high at the tunnel outlet, it is possible to anticipate an action modifying the parameters of the tunnel; and
   retroactive actions (countermeasures) calculated on the basis of the values obtained by the parameter or parameters of the second group, in order to rebalance a measured, effective drift in the quality of the exiting products, for example because the temperature of the frozen products at the outlet of the tunnel is too hot. Thus, for these products (which are too hot), it is too late to correct the method and obtain proper deep-freezing, but it is possible to adjust a colder setting of the tunnel in order that the following products exit at a satisfactory temperature.

### DETAILED DESCRIPTION OF THE INVENTION

As will be shown in more detail below, the present invention makes it possible to make the equipment easier to use: the user sets their temperature of frozen products, -20° C. for example, and the method according to the present invention manages all the rest, everything that needs to be managed.

The user no longer has to wonder: if I have a fairly hot product entering the tunnel, the flow rate is fairly high so do I need to put the tunnel at -110° C. rather than -100° C.?, the blowers at 90% rather than 50%?, the extraction at X or Y%?

And when the production conditions change, the user does not need to deal with the tunnel, it will adapt by itself to maintain a temperature of deep-frozen products at -20° C.

A cryogenic tunnel is known to generally have the following elements:
A conveyor for conveying products inside the tunnel: changing the speed of the conveyor changes the residence time of the products and their deep-freezing time.
a system for injecting cryogenic fluid into the space inside the tunnel, this system being made up, for example, of a valve for regulating the feed of cryogen into the tunnel, pipes and a plurality of nozzles for spraying the cryogen, this being supplemented by a controller that is able to modify the degree of opening of the valve in order to re-establish the temperature inside the tunnel to the level of a setpoint.
a ventilation system organizing the transfer of cold energy to the products.
means for extracting, at a variable flow rate, all or part of the cold gases resulting from the vaporization of the fluid in the tunnel, traditionally usually with extraction at the tunnel inlet and extraction at the tunnel outlet.
a data acquisition and processing unit, which is able to receive data from all of these devices (speed of the conveyor, speed of the blowers, speed of the extractors, temperature probes, etc.) and to act on all or some of these devices.

It is furthermore possible for there to be one or more of the following devices and the following data:
a given and chosen number of distance sensors, the role of which is to measure the thickness of products at different points along the conveyor. When there are no products on the conveyor, the distance measured is zero, whereas when a product arrives next to a sensor, this sensor, which is above the product, measures a distance which is equal to the thickness of this product (as a difference).
a controller receives all of these measurements and calculates an average thickness of the products present on the conveyor.
therefore, use is preferably not made of a scanning laser but of a group of several distance sensors making it possible to appropriately cover the dimensions of the tunnel in question, this being a more robust solution (fixed sensors not having moving parts).
a measurement of the speed of the conveyor.
the controller is than capable of carrying out the following evaluation: (average product thickness) × (width of the conveyor) × (speed of the conveyor) = (volumetric flow rate of products)
the temperature of the entering products, using a commercially available device therefor.
the temperature of the exiting products, again using a commercially available device therefor.
the flow rate of cryogen injected into the tunnel.
the temperature of the gases extracted from the tunnel, typically at the tunnel inlet and outlet.
the ambient temperature in the room accommodating the tunnel (and in particular for example the temperature prevailing in the vicinity of two extraction hoods at the tunnel inlet and outlet), and the ambient humidity and the atmospheric pressure in this room.
as mentioned above, there is advantageously a data acquisition and processing unit that is able to receive all of the data measured and to retroactively act for all the necessary actions, in particular the re-establishment of the setpoints, this unit (computer, automated controller or the like) may be situated in the vicinity of the tunnel in the room, or it is possible to adopt a configuration using such a local unit to send all of the data to a remote computer (network), this computer carrying out all of the calculations and evaluations before sending the results to the local unit, this local unit for its part then carrying out the necessary actions for modifying the parameters of the tunnel according to the invention.

With these two groups of clearly different parameters, a matrix is constructed for each group, such as those that will exemplified below in order to make the invention easier to understand:
The first group of measured parameters forms an input of the first matrix, this first group being used to calculate and trigger anticipation actions;
The second group of measured parameters forms an input of the second matrix, this second group being used to calculate and trigger retroactive actions.

As is described in detail below, the measurements obtained for one or more parameters of these two groups of parameters make it possible to calculate the adjustments to be made to a group of (anticipation and/or retroactive) action parameters, this group of actions being made up of:
The speed of the conveyor,
The speed of the blowers inside the tunnel,
The temperature of the gases coming from the inlet hood,
The temperature of the gases coming from the outlet hood,
The temperature setpoint prevailing inside the tunnel.

It should also then be noted that the second input of the two matrices is made up of the same group of parameters as the group of action parameters set out above.

As will be demonstrated below, the invention, in contrast to the prior art, does not act on just one parameter (for example only on the speed of the blowers or only on the thermal transfer) but on several parameters governing the operation of the tunnel.

To make the invention easier to understand, an example of a first matrix made up of the 1^{st} group of parameters and the anticipation actions carried out will be found below, each cell of this matrix being made up of a factor that establishes a link between a given parameter and a given anticipation action (anticipation action situated in said group of actions that are listed above).

In addition, an example of a second matrix made up of the 2nd group of parameters and the “retroactive” actions carried out will also be found below, each cell of this matrix being made up of a factor that establishes a link between a given parameter and a given retroactive action (retroactive action situated in said group of actions that are listed above).

Matrix of the 1^{st} group of parameters (so-called “anticipation” parameters)

| | | | | | |
|---|---|---|---|---|---|
| | Conveyor speed | Blower speed | Inlet hood gas temperature | Outlet hood gas temperature | Temperature setpoint inside the tunnel. |
| Temperature of entering products | x11 | x21 | x31 | x41 | x51 |
| Flow rate of entering products | x12 | x22 | x32 | x42 | x52 |
| Ambient temperature | x13 | x23 | x33 | x43 | x53 |
| Ambient humidity | x14 | x24 | x34 | x44 | x54 |
| Atmospheric pressure | x15 | x25 | x35 | x45 | x55 |

Matrix of the 2nd group of parameters (so-called “retroactive action” parameters)

| | | | | | |
|---|---|---|---|---|---|
| | Conveyor speed | Blower speed | Inlet hood gas temperature | Outlet hood gas temperature | Temperature setpoint inside the tunnel. |
| Temperature of exiting products | y11 | y21 | y31 | y41 | y51 |
| Flow rate of injected cryogen | y12 | y22 | y32 | y42 | y52 |
| Inlet hood gas temperature | y13 | y23 | y33 | y43 | y53 |
| Outlet hood gas temperature | y14 | y24 | y34 | y44 | y54 |
| Temperature in the vicinity of inlet hood | y15 | y25 | y35 | y45 | y55 |
| Temperature in the vicinity of outlet hood | y16 | y26 | y36 | y46 | y56 |

It should also be noted that if the content in certain cells is set to zero, it should be understood in their case that there is no action or retroactive action to be undertaken.

The actions that can be undertaken are exemplified in the following text:
If the cell indicated x11 is at -3, so when the temperature of the entering product is equal to 5° C., higher than the setpoint, the system will automatically adapt the speed of the conveyor by 5 x (-3) = -15 units (for example -15%). Consequently, for an entering product that is hotter than expected, the tunnel will, by anticipation, undertake a reduction in the speed of the conveyor and a longer deep-freezing time. In other words, the higher temperature of an entering product will automatically be anticipated and counterbalanced by the system.

The same type of action will also be defined in the matrix for each pair of parameters. In addition, if, in a given pair of parameters (a given cell), it is decided that no action is desired, the linking parameter will be set to zero (for example, the decision is made to set x12 to zero and thus the variations in flow rate of products will not bring about any action on the speed of the conveyor). This may for example be the case when it is desired for the conveyor to operate at constant speed. In this case, all the parameters of the matrix that have an impact on the speed of the conveyor will be set to zero. In the above example, x11 will be adjusted to zero.

For the second group of parameters (second matrix), the operation will be exemplified below.

Thus for example, if y51 = -0.5, the system will then carry out the following action: if a product exiting the tunnel has a temperature of 6° C., higher than the fixed setpoint, the tunnel will then automatically adjust the temperature inside the tunnel by 6 × (-0.5) = 3° C. i.e. by decreasing the setpoint by 3° C. per minute, step by step.

The temperature of the exiting products will thus decrease step by step, until the setpoint required at the outlet is reached. When the required set point has been obtained, the system stabilizes and the temperature setpoint in the tunnel will also be stabilized at the value that makes it possible to achieve optimal cooling of the product.

Again, if it is not desired to undertake any action on a given pair of parameters, the corresponding cell of the matrix is set to zero, for example if the cell y22 is set to zero, a variation in the flow rate of cryogen injected will not bring about any action on the speed of the blowers.

It is thus apparent, from the examples given here, that the actions are calculated differently but they act on the same group of action parameters, be this for the anticipation actions or the retroactive actions.

Whether it is detected that the products are arriving in too hot a state (it is then possible to envisage reducing the temperature of the tunnel by anticipation) or that the products are exiting in too cold a state (it is then possible to envisage reducing the temperature of the tunnel by retroactive action so that the following products are at the correct temperature), the action is the same.

In other words, there may be two different causes/origins for modifying a single tunnel parameter.

By contrast, a single parameter that brings about the modification of several parameters of the tunnel may also be observed.

As will be clearly apparent to a person skilled in the art, the matrices presented here can be established for a smaller number of parameters, or for a larger number of parameters, by adding parameters that are not listed here, for example for treating the tunnels provided with more than one conveyor, or with several temperature regions and therefore several temperature setpoints.

An example of the experimental determination of the values constituting the cells of the two matrices described above will be described in the following text.

To this end, to fill a cell, that is to say to determine the factor occupying the cell in question, a step-by-step procedure is carried out.

Consider the example of the factor y51 which establishes a relationship between the setpoint temperature of the deep freezer and the temperature of the products at the outlet of the deep freezer.

Step 1: the user puts the apparatus into operation with products. In order for this setting procedure to be successful, it is preferable, if not indispensable, for the method to be as stable as possible, for the flow rate and the temperature of the products to be frozen to be stable, and for the parameters of the deep freezer (speed of the blowers, speed of the belt, extraction speed) to likewise be stable.

Step 2: When the deep-freezing method is taking place stably, the regulating system that is the subject of the present invention is put into operation and a target temperature for the deep-frozen products at the outlet of the deep freezer is defined in accordance with the client’s needs. For the deep-frozen products, a target temperature of -20° C. will often be chosen.

The temperature of the deep-frozen product is then monitored by the user. Preferably, this temperature is recorded and the curve is constructed live.

Step 3: the parameter y51 is adjusted to a randomly chosen value, 1 for example. All the other parameter are adjusted to zero so as not to create interference between the control loops.

Step 4: the user then watches the behaviour of the temperature curve of the deep-frozen product for at least a time equivalent to 4 times the passage time of the product in the deep freezer:
case A: the temperature varies above and below the setpoint. The amplitude of the variation decreases rapidly during the passages and the temperature ultimately stabilizes very close to the setpoint. In this case, the user passes to step 5.
case B: the temperature curve remains below the setpoint. The user doubles the value of y51. If y51 was equal to 1, it changes to 2. The user then returns to the start of step 4.
case C: the temperature curve remains above the setpoint. The user doubles the value of y51. If y51 was equal to 1, it changes to 2. The user then returns to the start of step 4.
case D: the temperature curve is not stable, it passes above and below the setpoint with a stable or increasing amplitude. The user divides y51 by two. If y51 was equal to 1, it changes to 0.5. The user then returns to the start of step 4.
case E: the temperature curve is not stable, it passes above and below the setpoint with an amplitude that decreases very slowly. The user multiplies y51 by 0.7 (equivalent to -30%). If y51 was equal to 1, it changes to 0.7. The user then returns to the start of step 4.

Step 5: the user changes the setpoint temperature of the deep-frozen products and then watches the behaviour of the temperature curve of the deep-frozen product for at least a time equivalent to 4 times the passage time of the product in the deep freezer:
case F: the temperature varies above and below the setpoint. The amplitude of the variation decreases rapidly and the temperature ultimately stabilizes very close to the setpoint. In this case, the user has precisely determined the value of y51, a parameter making it possible to establish a control relationship between the pair of parameters described above.
case G: if the user is not in case F, they repeat the procedure from the start of step 4.

The same procedure could be applied to all the control parameters X or Y of the matrices of the present invention, that is to say to all the pairs of parameters of the method. The user will carry out the same procedure by adjusting each parameter X or Y one by one, taking care to adjust all the other parameters to 0 at the start of the procedure.

When this entire procedure has been completed, all the control parameters X of the method will have been determined.

Optimal control of the operation of the deep freezer will then be obtained.

The invention will be illustrated in the following text by a specific example: as mentioned above, when a cryogenic tunnel operates at a production site, numerous parameters may change at the same time, and all of these parameters have an impact on the deep freezing carried out.

If for example the flow rate of entering products increases by 20% and changes, by way of illustration, from 1000 to 1200 kg/h. If, at the same time, the temperature of the product decreases such that product requires 5% less cold (for example 95 calories/kg rather than 100).

The tunnel may then be considered, overall, to need to supply 1200 × 95 = 114 000 equivalent power as opposed to 100 000 previously. It therefore needs to supply 14% more energy.

The following text contains a summary of what will take place depending on the solution chosen by the user of the tunnel.
basic solution No 1 of the prior art without retroactive action (most widespread system): the tunnel will operate with an unchanged power of 100% and the product will therefore be insufficiently frozen by 14%;
solution No 2 involving a measurement of the temperature of the entering product: the system will detect a lower demand for cold since the product is arriving in a colder state, it will reduce the power of the tunnel by 5% and 19% less cold will be supplied to the product. It is apparent here that acting on just one parameter has a negative impact and in any event is less favourable than basic solution No 1.
solution No 3 involving a measurement of the flow rate of entering product: the system will detect a 20% increase in the flow rate and will trigger a 20% increase in the power of the deep freezer. The product will when be too cold at the outlet and the overconsumption may be evaluated as being 6%. The product will nevertheless be correct but this solution entails a production overcost of 6%.
solution No 4 according to the present invention: the system measures the temperature of the entering products and the flow rate of entering products (and, if necessary, other parameters), the system will then determine modifications to both parameters at the same time, it will make the necessary calculations and find that the resultant of these two modifications is equivalent to an increase in necessary power of 14%. It will therefore increase the power of the deep freezer by 14%, exactly what the method requires. The product will therefore exact in a correctly frozen state, at the correct temperature, and without overconsumption.

The invention could furthermore adopt one or more of the following embodiments:
all or some of the measurements taken are transferred to remote databases;
the data remotely stored in this way is processed to provide:
   i) information relating to the effectiveness of the deep-freezing method;
   j) a dynamic analysis of the deep-freezing tunnel, making it possible to provide in particular drifts in operation, or maintenance alerts, etc.

The present invention thus relates to a method for operating a cryogenic tunnel in which products to be cooled or deep-frozen circulate, the tunnel being equipped with means for injecting a cryogenic fluid and with means for extracting, at a variable flow rate, all or part of the cold gases resulting from the vaporization of said fluid in the tunnel, characterized in that:
Measurements are taken of several parameters qualifying the method,
These parameters are divided into two groups of different parameters, characterizing the tunnel:
   a first group made up of measured parameters which can be used to anticipate the future necessary deep-freezing power of the tunnel, this first group comprising one or more parameters from the following parameters:
      The temperature of the products entering the tunnel,
      The volumetric flow rate of the entering products,
      The mass flow rate of the products entering the tunnel,
      The colour of the products entering the tunnel,
      The level of coverage of the conveyor belt supplying the tunnel, or
      Parameters characterizing the atmosphere surrounding the tunnel in the room: ambient temperature, ambient humidity and atmospheric pressure.
   A second group of measured parameters that will be used to evaluate the final result of the exiting products, which parameters will in particular indicate whether the product has been correctly deep-frozen, this second group comprising one or more parameters from the following parameters:
      The temperature of the products exiting the tunnel,
      The flow rate of cryogen let into the tunnel,
      The temperature of the gases extracted from the tunnel, typically at two extraction hoods situated at the tunnel inlet and outlet,
      The temperature prevailing in the room in the vicinity of these two extraction hoods,
      The hardness of the products exiting the tunnel,
      The colour of the products exiting the tunnel,
      The percentage of the deep-frozen products that are of the IQF type,
Two types of actions are carried out on these parameters:
   Anticipation actions, calculated on the basis of the values obtained for the parameter or parameters of the 1^{st} group, in order to act in advance on an anticipated/expected deviation in the deep-freezing quality, for example because the temperature of the entering products is too high compared with a given setpoint, of anticipated actions, that is to say actions on the tunnel before the product exits for example in too hot or too cold a state, i.e. actions modifying parameters of the tunnel; and
   Retroactive actions (countermeasures) calculated on the basis of the values obtained for the parameter or parameters of the second group, in order to rebalance a measured, effective drift in the quality of the exiting products, for example because the temperature of the products at the outlet of the tunnel is too high compared with a given target temperature;

The anticipation or retroactive actions being determined by the outputs of the two following matrices governing said actions:
Said first group of measured parameters forms an input of a first matrix, this first group being used to trigger anticipation actions;
Said second group of measured parameters forms an input of a second matrix, this second group being used to trigger retroactive actions;

The measurements obtained for one or more parameters of these two groups of parameters making it possible to calculate the adjustments to be made to the group of (anticipation and/or retroactive) action parameters made up of:
The speed of the conveyor,
The speed of the blowers inside the tunnel,
The temperature of the gases coming from the inlet hood,
The temperature of the gases coming from the outlet hood,
The temperature setpoint prevailing inside the tunnel,

The second input of the two matrices being made up of said group of action parameters, and in that values making up the cells of the two matrices have been determined experimentally, each cell of these matrices being made up of a factor establishing a link respectively between a given parameter of the first group and a given anticipation action, and a given parameter of the second group and a given retroactive action.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

1. A method for operating a cryogenic tunnel in which products to be cooled or deep-frozen circulate, the tunnel being equipped with means for injecting a cryogenic fluid and with means for extracting, at a variable flow rate, all or part of cold gases resulting from vaporization of said fluid in the tunnel, the method comprising:
taking measurements of several parameters;
dividing the several parameters into two groups of different parameters, wherein
a first group made up of measured parameters which is used to anticipate the future necessary deep-freezing power of the tunnel,
a second group made up of measured parameters that is used to evaluate a final result of exiting products, which parameters indicate whether the product has been correctly deep-frozen; and
carrying out two types of actions on the parameters:
anticipation actions calculated on a basis of values obtained for the parameter or parameters of the first group, in order to act in advance on an anticipated/expected deviation in a deep-freezing quality; and
retroactive actions calculated on a basis of a values obtained for the parameter or parameters of the second group, in order to rebalance a measured, effective drift in the quality of the exiting products.

2. The method for operating the cryogenic tunnel according to claim 1, wherein
the first group of parameters comprises at least two parameters from the following parameters:
a temperature of the products entering the tunnel,
a volumetric flow rate of the products entering the tunnel,
a mass flow rate of the products entering the tunnel,
a colour of the products entering the tunnel,
a level of coverage of a conveyor belt supplying the tunnel, or
parameters characterizing the atmosphere surrounding the tunnel in the room: ambient temperature, ambient humidity and atmospheric pressure; and
said second group of parameters comprises at least two parameters from the following parameters:
a temperature of the products exiting the tunnel,
a flow rate of cryogen let into the tunnel,
a temperature of the gases extracted from the tunnel, typically at two extraction hoods situated at the tunnel inlet and outlet,
a temperature prevailing in the room in the vicinity of these two extraction hoods,
a hardness of the products exiting the tunnel,
acolour of the products exiting the tunnel, or
a percentage of deep-frozen products that are of the IQF type.

3. The method for operating the cryogenic tunnel according to claim 1, wherein the first group comprising one or more parameters from the following parameters:
a temperature of the products entering the tunnel,
a volumetric flow rate of the products entering the tunnel,
a mass flow rate of the products entering the tunnel,
a colour of the products entering the tunnel,
a level of coverage of the conveyor belt supplying the tunnel, or
prameters characterizing the atmosphere surrounding the tunnel in the room: ambient temperature, ambient humidity and atmospheric pressure.

4. The method for operating the cryogenic tunnel according to claim 1, wherein the second group comprising one or more parameters from the following parameters:
a temperature of the products exiting the tunnel,
a flow rate of cryogen let into the tunnel,
a temperature of the gases extracted from the tunnel, typically at two extraction hoods situated at the tunnel inlet and outlet,
a temperature prevailing in the room in the vicinity of these two extraction hoods,
a hardness of the products exiting the tunnel,
a colour of the products exiting the tunnel,
a percentage of deep-frozen products that are of the IQF type.

5. The method for operating the cryogenic tunnel according to claim 1, wherein the anticipation action is carried out when the temperature of the products entering the tunnel is high compared with a given setpoint of a target temperature.

6. The method for operating the cryogenic tunnel according to claim 1, wherein the retroactive action is carried out when the temperature of the products exiting the tunnel is high compared with a given setpoint of a target temperature.

7. The method for operating the cryogenic tunnel according to claim 1, wherein the anticipation or retroactive actions is determined by the outputs of the two following matrices governing the actions:
the first group of measured parameters forms an input of a first matrix, this first group being used to trigger anticipation actions; and
the second group of measured parameters forms an input of a second matrix, this second group being used to trigger retroactive actions.

8. The method for operating the cryogenic tunnel according to claim 1, wherein the measurements obtained for one or more parameters of these two groups of parameters making it possible to calculate adjustments to be made to the group of anticipation and/or retroactive action parameters made up of:
a speed of the conveyor,
a speed of the blowers inside the tunnel,
a temperature of the gases coming from the inlet hood,
a temperature of the gases coming from the outlet hood,
a temperature setpoint prevailing inside the tunnel.

9. The method for operating the cryogenic tunnel according to claim 1, wherein the second input of the two matrices being made up of said group of action parameters, and in that values making up the cells of the two matrices have been determined experimentally, each cell of these matrices being made up of a factor establishing a link respectively between a given parameter of the first group and a given anticipation action, and a given parameter of the second group and a given retroactive action.
